(19) United States
(12) Patent Application Publication
(10) Pub. No.: US 2002/0133696 A1
(43) Pub. Date: Sep. 19, 2002

(54) Klyako computer

(76) Inventor: Edin Dino Kljako, Chicago, IL (US)

Correspondence Address: Edin Dino Kljako, 4945 North Bell Street, Chicago, IL, 60625, US

(21) Appl. No.: 09/812,130

(22) Filed: Mar. 19, 2001

(51) Int. Cl. G06F 9/445

(52) U.S. Cl. 713/2

(57) ABSTRACT

A newly designed motherboard (mainboard), one each for desktop, laptop, and notebook computers, that would be used for storing operating system programs and files on a programmable rom chip. An erasable programmable rom chip, enough to hold a large operating system and the system bios, is installed on the motherboard. A hard disk would only be used to store applications programs and files.

Instead of ram, there would be an erasable programmable rom chip (the programs would load into this chip similar to ram). Portable eprom chips would be used to upgrade the size of the eprom (ram).

### CROSS REFERENCE

Not Applicable

### FEDERALLY SPONSORED RESEARCH

Not applicable

### REFERENCE TO MICROFICHE APPENDIX

Not applicable

### BACKGROUND OF THE INVENTION

This invention pertains generally to computer systems; in particular, a motherboard (mainboard) that employs the use of an erasable programmable rom chip to store an operating system and system files and programs, resulting in the elimination of a wait period for the loading of an operating system. The second erasable programmable rom chip replaces the ram on a system; this eprom chip allows the user to turn off the computer, turn it on again, and start where he left off before he turned the machine off.

This invention is an improvement to “bios” that other computer manufacturers incorporate in their system architectures. Not only does the programmable rom chip carry the system bios, files on a programmable rom chip that control peripheral operations, but rather, the operating system is stored on the eprom chip as well. This will eventually lead to the elimination of the hard disk as we know it (as soon as technology allows for the production of large capacity erasable programmable rom chips).

This invention also eliminates ram as we know it. Ram is replaced by an erasable programmable rom chip. This lets programs and files remain in memory until removed manually by the user. A person is able to turn the computer off, saving precious battery time on a laptop or notebook computer, and turn the computer back on again to start at the same place where he left off. The waiting period, loading of the operating system, re-initiating the program that the user was using, opening the file or files that the user was using, is completely eliminated.

Computer systems generally use a hard disk to store operating system files and programs. Files and programs for external peripherals are stored in system bios. In order for a person to start his computer, he would have to wait for the operating system to load itself into memory. The time period required to load these programs into ram is usually around a few seconds.

The present invention places the system and program files necessary to operate the computer in the erasable programmable memory chip; it also stores the operating system (windows or other os) on the same chip. This eliminates the time required to load programs and files into ram (erasable programmable rom chip). It employs an erasable programmable rom chip to store the operating system and support files. These files would be constantly in memory. The only thing that the user would be required to do is turn on the monitor and call up the program that he wishes to use.

### BRIEF SUMMARY OF THE INVENTION

It is the object of this invention to provide a computer with an erasable programmable memory chip that would hold an operating system's files and programs, eliminating the time required to load a large operating system. This computer system would allow the emergence of a first disk (erasable programmable rom chip) and a second disk (hard disk) for storing files and programs not associated with the operating system.

The hard disk will be eliminated as soon as technology allows the production of large capacity eprom chips. Once my computer becomes the standard in the industry, most chip manufacturers will shift their attention to producing high capacity eprom chips (or new hard disks).

### BRIEF DESCRIPTION OF THE SEVERAL VIEWS OF THE DRAWING

Not applicable

### DESCRIPTION OF THE PREFERRED EMBODIMENT

The KLYAKO COMPUTER employs 2 erasable programmable rom chips on the mother board. The addition of 2 eprom chips is an embellishment on computer architecture that makes everyday starting and shutting down a computer much quicker and easier. The first chip will be used to the store an entire operating system and programs and files that control peripheral operations (bios). The second eprom chip will serve in place of ram on the computer.

Since the first chip contains the os and programs that control peripherals, there is no wait time associated with loading of an operating system.

The second chip will allow a user to shut off his computer, turn it back on again, and start at the same place where he left off. In notebook or laptop computers, this will allow the user to save precious battery life. In desktop computers, this will save the operator from having to load programs and files into memory.

What I have done is made a computer that is on all the time. In actuallity, there is no start up or shut down. The operating system is loaded on an eprom chip and the program that the end user is using is stored in a second eprom chip (ram). The operating system is not stored in ram, however; it is stored in the erasable programmable rom chip (this rom chip operates like the bios chip that registers your hard disk or updates the time on a computer).

When installing a new peripheral, internal or external, the information in the eprom chip would be upgraded by a special program developed for the new architecture. In other words, the rom chip would be manipulated by an operating system program to allow the addition of a new peripheral or the addition of an improvement to an existing program. In order to remove a program or file from memory, the same program and a similar method would be used.

What is claimed is:

1. An erasable programmable rom chip (eprom) is installed on the motherboard. This chip is to contain not only the bios of the computer, but the operating system (windows or other) as well. This eliminates the time required for loading an operating system, thus speeding start and shut down operations for an end user. System files that control peripherals, resources such as disk drive, printer, monitor, and etc., would be stored on the same erasable programmable rom chip (an expansion of bios).

2. An erasable programmable rom chip would be installed on the motherboard to act as ram. This would be in addition to the eprom chip containing the bios and the operating system. Programs would be removed from memory simply by using a task bar or a task application (depending on the os that I select to use on the system).

3. A hard disk drive would be used only for storing files and programs not related to the system's files or programs, such as database programs, spreadsheets, word processing programs, and other user files. As the technology progresses, the hard disk will be an eprom chip installed on the motherboard (as soon as technology allows for high capacity (measured in gigabytes) eprom chips).
This makes the regular computer allways on. It speeds the start and shut down process that a user has to go through every visit to his computer. There actually isn't a shut down process. Since everything that a person is working on is in memory, and will remain there even after shut off, there is no need to close any programs or the operating system. A person could shut off his computer in the middle of his work, turn it back on again, and start where he left off.
